(19) United States
(12) Patent Application Publication
(10) Pub. No.: US 2015/0014252 A1
(43) Pub. Date: Jan. 15, 2015

(54) WATER BOTTLE COUPLED WITH FILTRATION DEVICE

(71) Applicant: Jonatas Justus, SR., Maringa (BR)

(72) Inventor: Jonatas Justus, SR., Maringa (BR)

(21) Appl. No.: 13/941,577

(22) Filed: Jul. 15, 2013

(51) Int. Cl. C02F 1/00; C02F 1/28

(52) U.S. Cl. CPC C02F 1/003; C02F 1/283
USPC 210/668; 210/669; 210/416.3; 210/222

(57) ABSTRACT

Water bottle coupled with a filtration cartridge including a plastic reservoir sufficiently flexible so that it can be gripped and squeezed, a drinking cap removably attached to the reservoir, a replaceable filtering element removably coupled with the drinking spout portion of the cap through which water inside the reservoir passes before being released through the spout. The removable filter includes and entry and an exit layer of felt and a layer of activated charcoal mixed with zeolite to reduce chlorine, trihalomethanes, organochlorines and heavy metals. The reservoir can fits into a magnetized base which can also be embedded in the body of the reservoir, and a cover to cover the cap and spout which dispenses purified water to the consumer.

### FIELD OF THE INVENTION

This invention relates to water filtration and, in particular, to methods, systems and devices for a water bottle having a water filtration device coupled within the water bottle to filter the enclosed water as the user drinks from the water bottle.

### BACKGROUND OF THE INVENTION

Plastics play an important role in almost every aspect of our lives. Plastics make up more than 12 percent of the municipal solid waste stream, a dramatic increase from 1960, when plastics were less than one percent of the waste stream. According to the EPA, 31 million tons of plastic waste were generated in 2010. Only 8 percent of the total plastic waste generated in 2010 was recovered for recycling.

The fact is, environmentally, single use plastic water bottles make no sense. Yet for some reason consumers been convinced that this is the only way to drink water. The public has also being taught that the water coming into his house is no longer drinkable. While the water provided to millions of homes across the county is drinkable, it can contain chemicals and other impurities that continue to concern consumers.

One solution to the problem of tons of waste from single use plastic water bottles is to filter the tap water delivered to the home. Filtering systems can include filter cartridges connected with the kitchen faucet and filters used with large water pitchers such as the Brita® water pitcher with filter that uses an ion resin exchange to reduce lead, copper, mercury, cadmium, zinc, and other impurities from drinking water. While the water pitcher is useful at home, consumers drink water away from home where water faucets and drinking fountains are often provided.

Known U.S. patents include U.S. Pat. No. 8,337,697 issued Dec. 25, 2012 which teaches a Multi-compartment water purification bottle having a replaceable filter. The bottle includes a cap, a reservoir closeable by the cap, and a filter holder that houses a filter, the filter holder being coupled to the cap such that a liquid in the reservoir is filtered by the filter as the liquid is being consumed. The filters can be constructed out of high reactivity carbon mixture, activated carbon, iodinated resin, and combinations thereof, or any other suitable compositions for filtering water or other liquids; U.S. Pat. No. 7,810,651 describes a flexible water bottle with a filter assembly located within the cap of the bottle. The filter assembly includes paper filters covering the upper and lower ends and can include an activated charcoal filter between the paper filters; U.S. Pat. No. 6,395,170 describes a universal filter for soda pop and bottled water bottles, adapted to fit and seal into a bottle neck without modification of, or attachment to, the bottle or its cap or other closure; U.S. Patent Application 2012/0255890 describes a water filter that can be attached to the cap of a beverage bottle; U.S. Pat. Nos. 5,914,045 and 5,609,759 teach a filter assembly for a flexible, portable bottle with the filter body is made from a porous plastic material having a powdered activated carbon therein; and U.S. Pat. No. 6,569,329 describes a bottle mountable filtration system.

### BRIEF SUMMARY OF THE INVENTION

The present invention overcomes the problems outlined above and advances the art by providing a plastic water bottle coupled with a filtration system. The plastic water reservoir is contoured for easy gripping, and is sufficiently flexible to allow it to be squeezed, forcing water into the bottom of the filtration system. The filtration system includes a filtration cartridge such that are water from the reservoir is drawn into the filtration cartridge such that the water travels the length of the cartridge before being dispensed through the spout on the top of the bottle.

The filtration system includes a filter cartridge with a layer of felt material at the entrance of the cartridge and a felt layer at the exit. The entry and exit felt layers removes dirt. Sandwiched between the two felt layers is a layer of activated charcoal mixed with zeolite to reduce chlorine, trihalomethanes, organochlorines and heavy metals. In addition, the activated charcoal mixed with zeolite layer and has bactericidal properties.

The plastic water bottle coupled with a filtration system can include a base that snugly holds the bottom of the water bottle. This base is magnetized and imparts magnetic energy through the body of the bottle. The bottle also comes paired with a plastic cover that fits over the spout, to keep filtered water from spilling out.

Each replaceable cartridge can purify 150 liters of water, equivalent to 300 bottles at 500 ml. Because the water bottle uses a replaceable filtering cartridge, the bottle coupled with the filtration system should reduce the number of disposable plastic bottles that are discarded indiscriminately and/or disposed of in landfills. If each consumer uses three to four cartridges per year, that will remove approximately 1,000 plastic bottles from our landfills and landscapes every year.

Further objects and advantages of this invention will be apparent from the following detailed description of preferred embodiments which are illustrated schematically in the accompanying drawings.

### BRIEF DESCRIPTION OF THE DRAWINGS

FIG. 1 shows a water bottle that has a filter cartridge coupled with the cap according to the present invention.

FIG. 2 shows an exploded view of the filtration device.

### DETAILED DESCRIPTION OF THE INVENTION

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

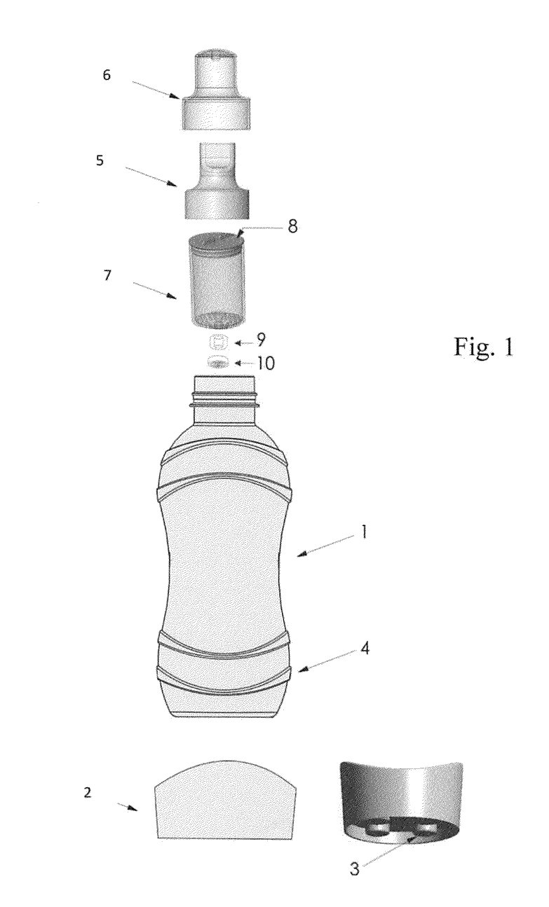

FIG. 1 illustrates a water bottle shape determined to be the most functional and comfortable for gripping easily with one hand and is sufficiently flexible to allow it to be squeezed, forcing water into the bottom of the filtration system. This figure is merely illustrative; those skilled in the art understand that the water bottle and coupled water filtration may vary in insignificant ways that do not affect the viability of the filtration process as described.

The following numbering system identifies each part of the bottle and filtration system and offers a detailed view of each part of the product and the manner in which they are configured.
1 reservoir
2 base
3 magnets
4 fitting rib
5 removable bottle cap
6 cover
7 filter cartridge
8 vents in filter top
9 inlet valve
10 valve cover

The method, apparatus and system of the present invention provides a plastic water bottle coupled with a filtration system. The plastic water reservoir is contoured for easy gripping, and is sufficiently flexible to allow it to be squeezed, forcing water into the bottom of the filtration system such that are water from the reservoir is drawn into the filtration cartridge. The water travels the length of the cartridge before being dispensed through the spout on the top of the bottle cap.

The water bottle and filtration system can include a base that snugly holds the bottom of the water bottle. This base is magnetized and imparts magnetic energy through the body of the bottle. The bottle can also include a plastic cover that fits over the spout, to keep filtered water from spilling out.

The filter mates with the cap and integral spout and can snap into the cap or can include mating threads, or any other suitable attaching means The filter includes multiple vents/holes at the top and bottom of the filter to allow water from the reservoir to enter the filter, flow freely through the filter, with filtered water exiting directly into the water bottle spout. Water is filtered when pressure generated by squeezing the bottle forces water from the reservoir through the filter along an axial flow path and out through the spout.

The water bottle can have various shapes. In a preferred embodiment shown, the water bottle has a generally flat bottom, can be contoured such as an hour glass shape for easy gripping and squeezing of the water bottle during use. Alternative shapes such as but not limited to different geometrical shapes can also be used water bottle. Similarly, the exterior surface can have different appearances. For example, the outer appearance can be clear, can have a patterned appearance such as a camouflage appearance, or the outer appearance can be a single color. Similarly, the outer surface of the holder 30 can be smooth, textured and or can include longitudinal ridges or recesses for gripping.

The water bottle and thus the filtration cartridge can be made in different sizes for different uses. For example, a smaller size water bottle can be appropriate for a child while a medium size may be more suitable for teenager or young adult. The size can also be varied for different uses. For example, a medium water bottle may suitable for the gym while a larger water bottle can be used when hiking, boating, or engaging in other outdoor activities where water is not readily available.

One skilled in the art should realize that the approximate and preferred dimensions should not be construed as limitations of the preferred embodiment. Various water bottle shapes and corresponding storage filtration cartridge size and shape may be chosen and optimized for a particular application to achieve a desired performance.

Referring to FIG. 1, in the preferred embodiment the water bottle is a contoured flexible reservoir/bottle with a flexible body 1 that can be securely fitted on a base 2 containing magnets 3. The base 2 mates with the fitting rib 4 on the bottle. Unpurified water fills the reservoir and as the sides of the bottle are squeezed, the unfiltered water passes through a filter cartridge 7 which is secured to the bottle cap. The threaded bottle cap integrating the drinking spout 5 can be protected by a harder plastic cover 6 that is pressure-secured over the threaded bottle cap 5.

Connected within the threaded cap, attached either with a threaded or pressurized connection, is the replaceable filtration cartridge 7 that purifies the water contained in the flexible reservoir 1. When the body of the flexible reservoir 1 is squeezed, it creates enough pressure to force water through the filtering cartridge 7 and out through the spout 5 integrated with the bottle cap. To prevent leakage of water from around the bottle cap when the reservoir is squeezed, an o-ring can be in the bottle cap to seal the liquid contents within the water bottle.

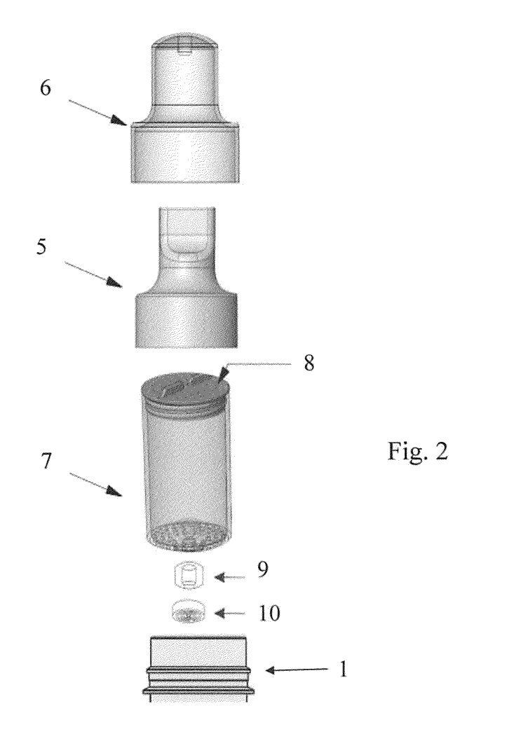

Multiple vents 8 located in the top and bottom of the filter cartridge 7 allow unfiltered water to enter the filter cartridge 7, pass through the filter cartridge 7, then exit directly into the spout of the bottle cap 5. Water has only one way to reach the spout 5, via the holes 8 located at the top of the cartridge 7. In order to compensate for the water that passes through the cartridge 7 and spout 5 without introducing air-borne contaminants to the filtered water remaining in the reservoir 1, one air inlet valve 9 with a valve cover 10 is located at the bottom of the filter cartridge 7 as shown in FIG. 2 to control passage of water from the reservoir 1 into and through the filter cartridge 7.

The replaceable filter cartridge contains materials that result in water purification, and reduction of particulates in suspension, including heavy metals, trihalomethanes, ammonia, residual chlorine, and pathogenic microorganisms, that would otherwise cause an unpleasant taste, and bad odor. It also regulates the pH of the water, leaving it slightly alkaline.

The replaceable filter cartridge contains a layer of felt material at the entrance of the cartridge and a second felt layer at the exit. The entry and exit felt layers remove dirt. Sandwiched between the two felt layers is an activated charcoal mixed with zeolite layer to reduce chlorine, trihalomethanes, organochlorines and heavy metals. In addition, the activated charcoal mixed with zeolite layer and has bactericidal properties.

As shown in FIG. 1, the plastic water reservoir 1 is contoured for easy gripping, and is sufficiently flexible to allow it to be squeezed, forcing water into the bottom of the filtration cartridge 7 where the water travels the length of the cartridge 7 before being dispensed through the spout of the bottle cap 5.

As a safety feature, nanotechnology is used in impregnating the part of the cap and spout that contacts with the water and the mouth with colloidal silver, preventing the proliferation of bacteria. Complementing the filtration cartridge is a base 2 or stand for the bottle 1 that contains magnets 3 which generate a magnetic field that revitalizes the water, helping to relax compressed hydrogen and oxygen molecules so they return to their natural state, making the water more easily absorbed by the body. Each replaceable cartridge can purify 150 liters of water, equivalent to 300 bottles at 500 ml per bottle.

The removable water bottle stand 2 is shaped to snugly fit onto the bottom of the water bottle 1. This removable stand is shaped to fit onto a base of the countered reservoir and has one or more magnet embedded therein to generate a magnetic field that impart magnetic energy through the body of the bottle to revitalize the water in the reservoir when the reservoir is pressure fitted into the stand. The water bottle also comes paired with a plastic cover 6 that pressure fits over the bottle cap and spout 5, to keep filtered water from spilling out.

Those skilled in the art will appreciate that the above-described principles could be applied to other water bottle designs to realize the advantages of the present invention. Those skilled in the art will also appreciate variations of the above described embodiments that fall within the scope of the invention. As a result, the invention is not limited to the specific examples and illustrations discussed above, but only by the following claims and their equivalents.

I claim:

1. A method for filtering water contained in a bottle and dispensing filtered water comprising the steps of:
providing a contoured reservoir with a flexible body closed at one end and having a threaded neck at an opposite end;
providing a threaded bottle cap integrating a drinking spout, the threaded cap mating with the threaded neck of the reservoir;
providing a replaceable filter cartridge having an entrance end and an exit end each having multiple apertures and a first layer of felt material at the entrance of the cartridge adjacent to the entrance apertures and a second felt layer at an exit of the filter cartridge adjacent to the second felt layer and a filtration material sandwiched between the first and second felt layers;
removably attaching a replaceable filter cartridge into the threaded bottle cap; and
wherein when the body of the flexible reservoir is squeezed, it creates enough pressure to force water stored in the reservoir through the filter cartridge and out through the spout integrated with the bottle cap.

2. The method of claim 1 wherein the step of providing a threaded bottle cap comprises the steps of:
impregnating the drinking spout of the bottle cap with colloidal silver to prevent proliferation of bacteria.

3. The method of claim 1 wherein the step of removable attaching a replaceable filter cartridge comprises the steps of:
pressure fitting the filter cartridge into a mating recess in the bottle cap.

4. The method of claim 3 further comprising the step of:
providing a gasket in the bottle cap to improve water tightness between the filtered water in the pressure fitted filter cartridge and the spout of the removable bottle cap.

5. The method of claim 1 wherein providing a replaceable filter cartridge further comprises the steps of:
sandwiching a layer of activated charcoal mixed with zeolite between the first and second felt layers to to reduce chlorine, trihalomethanes, organochlorines and heavy metals.

6. The method of claim 5 further comprising the step of:
providing an air inlet valve with a valve cover at the bottom of the filter cartridge to control passage of water from the reservoir into and through the filter cartridge.

7. The method of claim 1 further comprising the step of:
providing a removal stand shaped to fit onto a base of the countered reservoir, the removable stand having a magnet embedded therein to generate a magnetic field to revitalize the water in the reservoir when the reservoir is pressure fitted into the stand.

8. The method of claim 1 further comprising the step of:
providing a plastic cover that pressure fits over the bottle cap and spout to keep filtered water from spilling out.

9. A drinking water bottle with filtration comprising:
a contoured reservoir with a flexible body closed at one end and having a threaded neck at an opposite end;
a threaded bottle cap integrating a drinking spout, that threaded bottle cap mating with the threaded neck of the reservoir;
a replaceable cylindrical filter cartridge which is secured into the threaded bottle cap, the replaceable filter cartridge having an entrance end and an exit end each having multiple vents, a first layer of felt material at the entrance of the filter cartridge and a second felt layer at an exit of the filter cartridge; and
wherein when the body of the flexible reservoir is squeezed, it creates enough pressure to force water through the filtering cartridge and out through the spout integrated with the bottle cap.

10. The water bottle of claim 9 wherein the replaceable filter cartridge further comprises:
a layer of activated charcoal mixed with zeolite sandwiched between the first and second layers of felt to reduce chlorine, trihalomethanes, organochlorines and heavy metals.

11. The water bottle of claim 9 wherein the replaceable filter cartridge is threaded into the cap of the water bottle.

12. The water bottle of claim 9 wherein the replaceable filter cartridge is pressurized fitted into a mating recess in the spout of the bottle cap.

13. The water bottle of claim 9 further comprising:
a gasket in the bottle cap to improve watertightness between the pressure fitted filter cartridge and the spout of the removable bottle cap.

14. The water bottle of claim 9 further comprising the step of an air inlet valve with a valve cover 10 at the bottom of the filter cartridge to control passage of water from the reservoir into and through the filter cartridge without introducing air-borne contaminants to the water remaining in the reservoir.

15. The water bottle of claim 9 further comprising:
a removal stand shaped to fit onto a base of the countered reservoir, the removable stand having a magnet embedded therein to generate a magnetic field to revitalize the water in the reservoir when the reservoir is pressure fitted into the stand.

16. The water bottle of claim 9 further comprising:
a plastic cap that is pressure-secured over the threaded bottle cap.

17. The water bottle of claim 9 further comprising:
a magnet embedded in the body of the reservoir to impart magnetic energy through the body of the bottle to relax compressed hydrogen and oxygen molecules so they return to their normal state.
